(19) United States
(12) Patent Application Publication
(10) Pub. No.: US 2026/0203769 A1
(43) Pub. Date: Jul. 16, 2026

(54) GENERATING ACTION RECOMMENDATIONS IN INCIDENT MANAGEMENT

(71) Applicant: PagerDuty, Inc., San Francisco, CA (US)

(72) Inventors: Irena Grabovitch - Zuyev, Quispamsis (CA); Jonathon Eric Bloxham Grieman, North Vancouver (CA); Scott James Bastek, Lisbon (PT); Sean Robert Noble, Toronto (CA); Kevin Qing Liu, San Rafael, CA (US); Mathieu Robert Trudel, Toronto (CA); June Ursula Naomi Epstein, Toronto (CA); Julianna Genevieve Green, Milwaukie, OR (US)

(21) Appl. No.: 19/022,638

(22) Filed: Jan. 15, 2025

(51) Int. Cl. G06Q 30/015

(52) U.S. Cl. CPC G06Q 30/015

(57) ABSTRACT

Actions available for a reference incident are identified. Past incidents upon which at least one of the available actions was performed are identified as connected incidents. For each connected incident, a respective similarity score is calculated with respect to the reference incident. A subset of the connected incidents having highest similarity scores as similar connected incidents is selected. a subset of the available actions that were performed with respect to the similar connected incidents is identified. The subset of the available actions is provided as recommended actions for the reference incident.

### TECHNICAL FIELD

This disclosure relates generally to computer operations and more particularly, but not exclusively, to generating action recommendations.

### SUMMARY

A first aspect of the disclosed implementations is a method that includes identifying actions available for a reference incident; identifying, as connected incidents, past incidents upon which at least one of the available actions was performed; calculating, for each connected incident, a respective similarity score with respect to the reference incident; selecting a subset of the connected incidents having highest similarity scores as similar connected incidents; identifying a subset of the available actions that were performed with respect to the similar connected incidents; and providing the subset of the available actions as recommended actions for the reference incident.

A second aspect of the disclosed implementations is a system that includes one or more memories and one or more processors. The one or more processors are configured to execute instructions stored in the one or more memories identify actions available for a reference incident; identify, as connected incidents, past incidents upon which at least one of the available actions was performed; calculate, for each connected incident, a respective similarity score with respect to the reference incident; select a subset of the connected incidents having highest similarity scores as similar connected incidents; identify a subset of the available actions that were performed with respect to the similar connected incidents; and provide the subset of the available actions as recommended actions for the reference incident.

A third aspect of the disclosed implementations is one or more non-transitory computer readable media storing instructions operable to cause one or more processors to perform operations. The operations include identifying actions available for a reference incident; identifying, as connected incidents, past incidents upon which at least one of the available actions was performed; calculating, for each connected incident, a respective similarity score with respect to the reference incident; selecting a subset of the connected incidents having highest similarity scores as similar connected incidents; identifying a subset of the available actions that were performed with respect to the similar connected incidents; and providing the subset of the available actions as recommended actions for the reference incident.

These and other aspects of the present disclosure are disclosed in the following detailed description of the embodiments, the appended claims and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system for event management.

FIG. 5 is a block diagram of example functionality of an action recommendation software for identifying recommended actions to perform with respect to incidents.

FIG. 6 illustrates an example of identifying connected incidents by a connected incidents identification tool for a reference incident.

FIG. 7 illustrates an example of a user interface for displaying recommended actions.

FIG. 8 is an example of a flowchart of a technique for identifying recommended action with respect to a reference incident.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to an information technology (IT) service of an organization. An event can be or describe a fact at a moment in time that may consist of a single or a group of correlated conditions that have been monitored and classified into an actionable state. As such, a monitoring tool of an organization may detect a condition in the IT environment (e.g. such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires the performance (by a human or an automated task) of an action. Thus, the alert may embody or include the action to be performed.

An incident associated with an alert may or may not be used to notify the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

In resolving an incident, a responder may need to have various types of actions performed with respect to the incident. These actions may include diagnostic actions (e.g., collecting logs), remediation actions (e.g., restarting services), configuration changes (e.g., modifying resource allocations), verification actions (e.g., validating service status), and/or some other types of actions. When a responder selects an action, mechanisms of the EMB execute the corresponding operations on the affected systems or services.

In conventional incident response systems, when an incident occurs, responders are typically presented with a list of available actions based on predefined mappings and basic filtering rules. Such systems may rely on simple database queries to generate action lists, often displaying them alphabetically or grouped by basic categories. While such systems can retrieve and display available actions, they lack the technical capability to determine which actions are most likely to be effective for resolving the specific incident or assisting in diagnosing what caused the incident. Such systems may treat all available actions as equally relevant and useful.

These conventional systems may process incidents in isolation, without computational analysis of similarities between incidents or consideration of temporal patterns. This technical rigidity prevents them from leveraging computationally efficient models to process incident data and provide actionable insights, such as identifying recommended actions to apply with respect to incidents. Consequently, responders are left with a computationally suboptimal system that neither adapts to evolving data patterns nor scales effectively with the growth of automation libraries.

Implementations according to this disclosure address these limitations by introducing an intelligent action recommendation system that dynamically suggests automation actions based on historical incident data, incident similarity patterns, and action usage history. The system identifies “connected incidents” by analyzing attributes such as service identifiers, escalation policies, incident titles, and temporal proximity. By applying a weighted similarity model, the system ranks actions based on their relevance to the current incident and prioritizes those that have been used in similar situations. This approach reduces the time needed to identify relevant actions, improves consistency in incident response across team members with varying experience levels, and decreases incident mean-time-to-resolution. Additionally, the system continually adapts to new data, improving the accuracy and relevance of recommendations over time.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, received, etc.) by an event management bus. An event management bus (which can also be referred to as an event ingestion and processing system) may be configured to monitor various types of events depending on the needs of an industry and/or technology area. For example, IT services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof. An event (e.g., an event object) may be directly created (such as by a human) in the EMB via user interfaces of the EMB.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder,” as used herein, can refer to a person or entity, represented or identified by persons, who may be responsible for responding to an event associated with a monitored application or service. A responder is responsible for responding to one or more notification events. For example, responders may be members of an IT team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

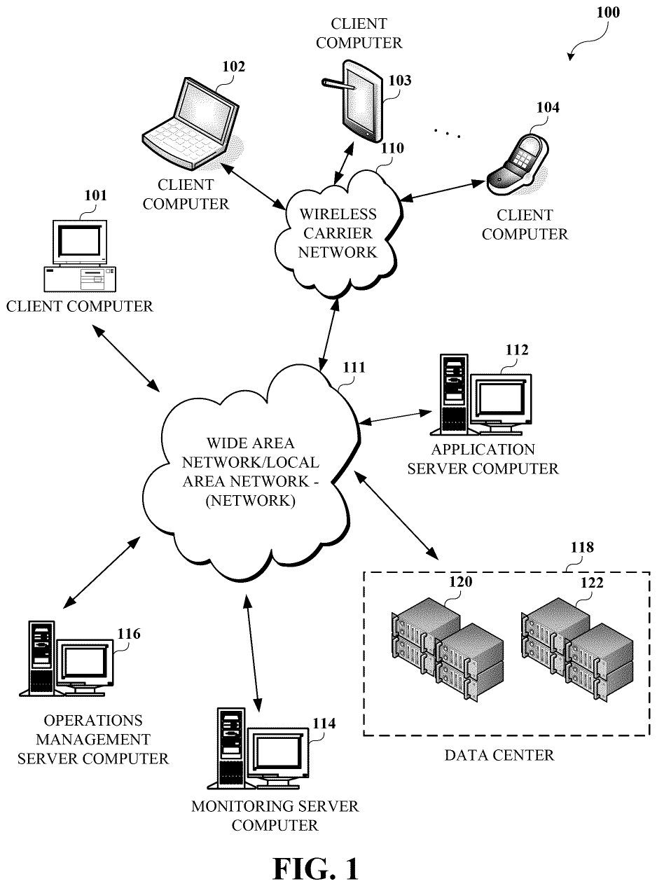

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

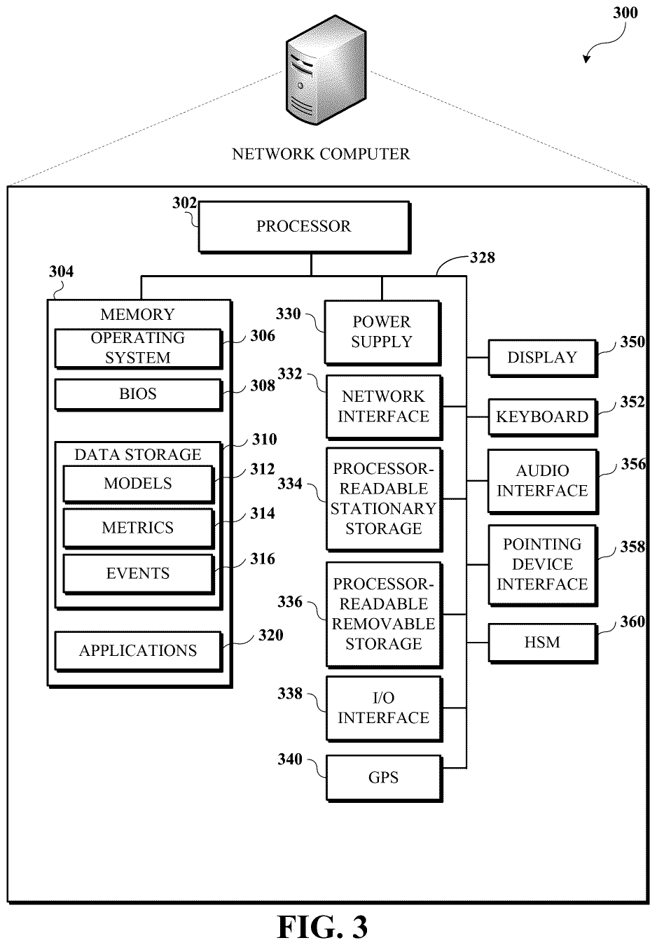

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

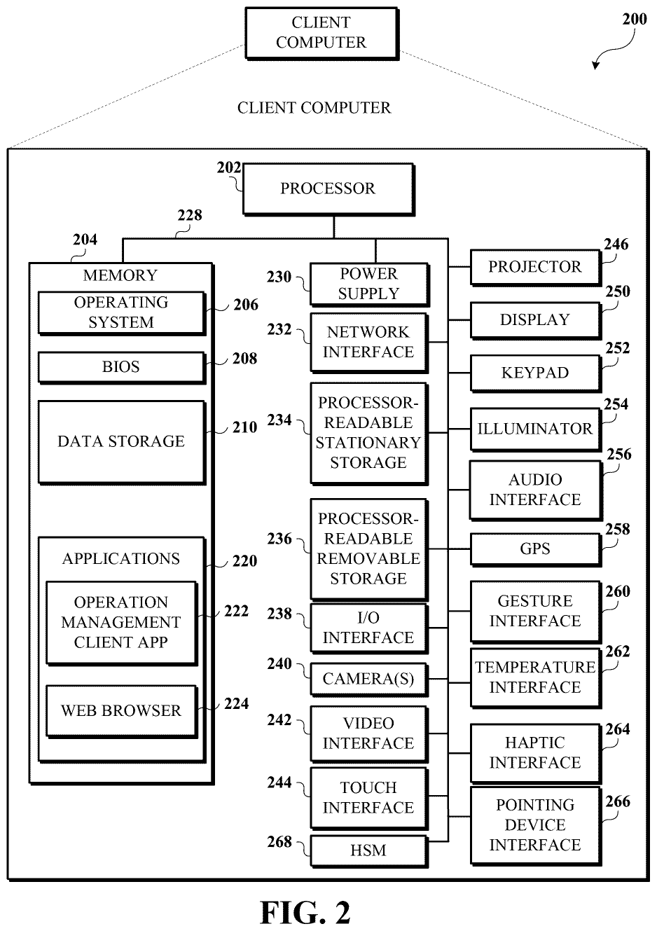

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 224 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Inc.'s IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for generating smart incident status updates using generative artificial intelligence. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, which include the management platform may be executing within virtual machines or virtual servers that may be managed in a cloud-based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces as well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 110 or the network 111.

Also, in at least one of the various embodiments, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

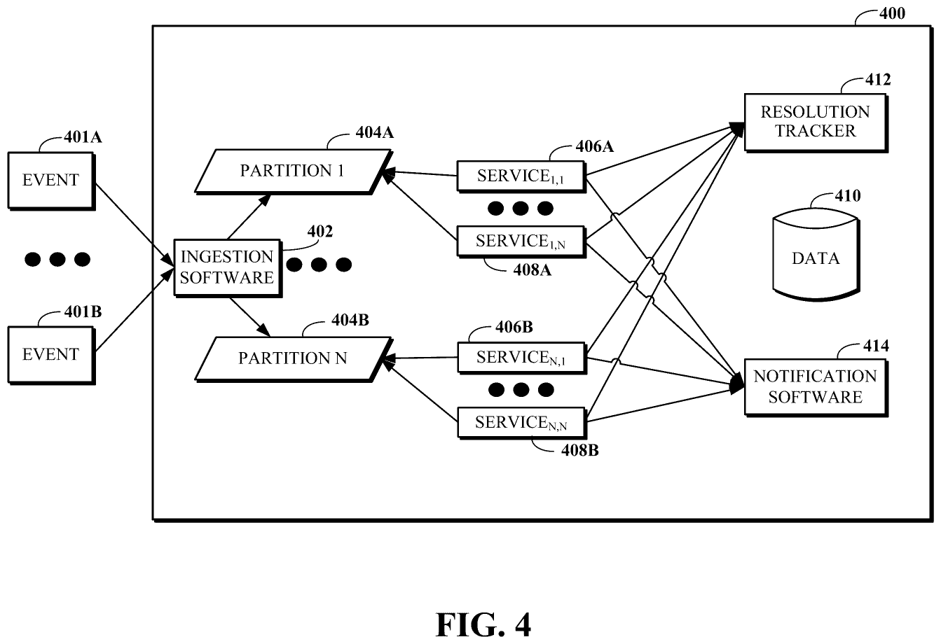

FIG. 4 illustrates a logical architecture of a system 400 for event management. In at least one of the various embodiments, a system for automatically generating smart incident status updates may include various components. In this example, the system 400 includes an ingestion software 402, one or more partitions 404A-404B, one or more services 406A-406B and 408A-408B, a data store 410, a resolution tracker 412, and a notification software 414.

One or more systems, such as monitoring systems, of one or more organizations may be configured to transmit events to the system 400 for processing. The system 400 may provide several services. A service may, for example, process an event and determine whether a downstream object (e.g., an incident) is to be triggered. As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by the same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An (e.g., each) event may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated metadata, such as, a title (or subject), a source, a creation time stamp, a status indicator, a region, more information, less information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store, inter alia, incident data. An incident may be represented as an object in the data store 410. For brevity, an incident object is simply referred to as an incident. In an example, the incident data may be notes (textual or otherwise) entered in association with the incident by responders. The incident data may include an association to one or more responders, such as those assigned to the incident. The set of notes associated with an incident may be referred to as an incident timeline. In an example, at least some of the notes of the incident timeline may be programmatically obtained, by one or more components of the system 400, from other systems.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may be associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification software 414 may generate one or more notification messages and determine a particular message provider to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification software 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured.

In at least one of the various embodiments, the system 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate playbooks with certain types of objects. A playbook can include a set of actions that can implement or encapsulate a standard operating procedure for responding to (e.g., remediating, etc.) events of certain types. Playbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a playbook may be associated with a template. As such, if an object matches the template, then the tasks of the playbook can be performed (e.g., executed, orchestrated, etc.) according to the order, rules, and/or workflow specified in the playbook. In another example, the playbook can be associated with a type. As such, if an object is identified as being of a certain type, then the tasks of the playbook associated with the certain type can be performed. A playbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the system 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

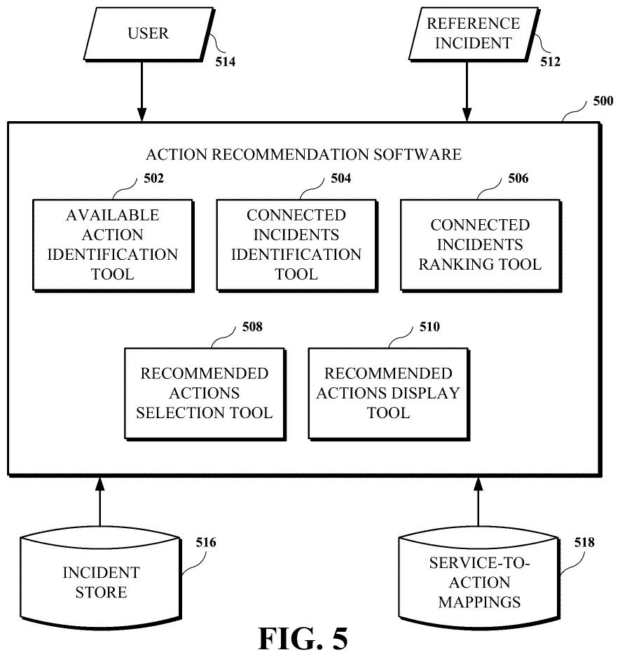

FIG. 5 is a block diagram of example functionality of an action recommendation software 500 for identifying recommended actions to perform with respect to incidents. The action recommendation software 500 can be implemented by or included in an EMB, such as the system 400 of FIG. 4. The action recommendation software 500 includes tools, such as programs, subprograms, functions, routines, subroutines, operations, executable instructions, and/or the like for, inter alia and as further described, identifying recommended actions to perform (e.g., execute) with respect to incidents.

At least some of the tools of the action recommendation software 500 can be implemented as respective software programs that may be executed by one or more computing devices, such as the network computer 300 of FIG. 3. A software program can include machine-readable instructions that may be stored in one or more memories such as one or more of the memory 304, and that, when executed by one or more processors, such as the processor 302 of FIG. 3, may cause the computing device to perform the instructions of the software program.

As shown, the action recommendation software 500 includes an available action identification tool 502, a connected incidents identification tool 504, a connected incidents ranking tool 506, a recommended actions selection tool 508, and a recommended actions display tool 510. In some implementations, the action recommendation software 500 can include more or fewer tools. In some implementations, some of the tools may be combined, some of the tools may be split into more tools, or a combination thereof.

At a high level, the action recommendation software 500 identifies recommended actions to be applied to a reference incident 512 (i.e., a current incident that the user 514 may be viewing or otherwise interacting with) by or on behalf of the user 514. To identify the recommended actions, the action recommendation software 500 employs a collaborative filtering technique similar to recommendation algorithms used in content recommendation platforms, personalized recommendation system, behavior-driven recommendation systems, or the like.

In traditional collaborative filtering, recommendations are based on matching user preferences to items, such as movies or shows, where extensive user profiles and historical behavior data are available. However, unlike such systems, where robust user profiles developed over thousands of interactions can be relied upon, the action recommendation software 500 operates in an environment where a reference incident is often net new, meaning that there may be little or no historical data specific to the reference incident itself. As a result, the action recommendation software 500 can be thought of as developing proxies to infer meaningful action recommendations.

The action recommendation software 500 addresses this challenge by analyzing historical incident data stored in an incident store 516, which may be the data store 410 of FIG. 4. The incident store 516 contains detailed records of past incidents and indications of the actions applied (e.g., selected with respect to) those historical incidents. To overcome the lack of direct historical data for new incidents, the action recommendation software 500 identifies and analyzes connected incidents-past incidents that share contextual and operational similarities with the current incident. These similarities are determined through a combination of textual analysis of incident titles and descriptions, temporal correlation of incident occurrence and resolution times, and attribute-based matching of metadata such as service identifiers, escalation policies, and user roles.

By leveraging connected incidents as proxies, the action recommendation software 500 simulates a collaborative filtering approach, matching the reference incident 512 to actions that have been historically used in resolving similar incidents. This proxy-based model ensures that meaningful recommendations can be generated even when limited or no prior data exists for the specific, reference incident 512. The action recommendation software 500 continuously (e.g., for every incoming incident) refines its recommendations by dynamically analyzing patterns across historical incidents and incorporating additional dimensions such as recency, invocation frequency, and contextual relevance.

The available action identification tool 502 identifies actions available to be applied to the reference incident 512. The available action identification tool 502 may generate a set of available actions based on predefined service-to-action mappings 518 and/or user-specific constraints.

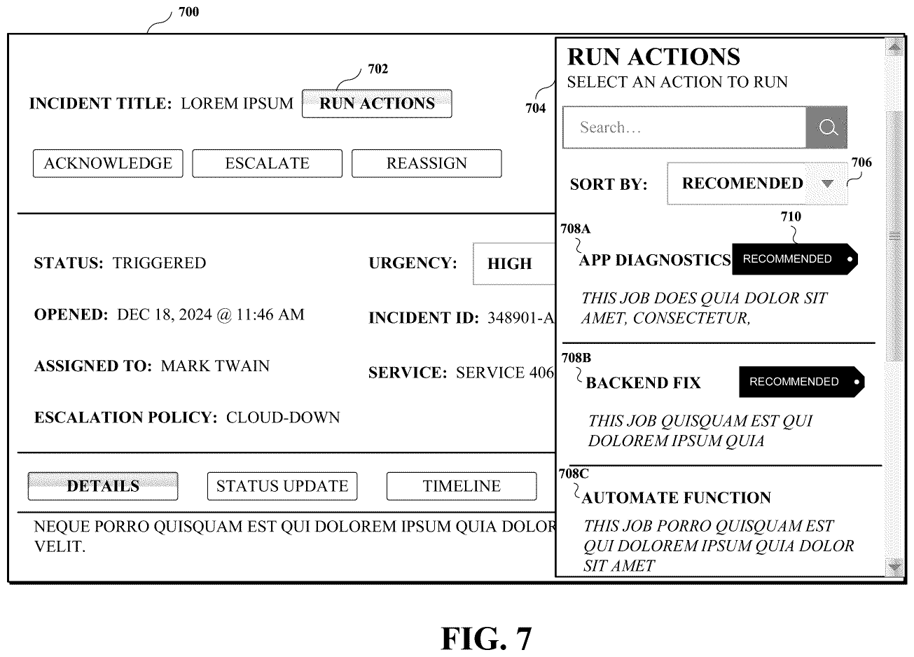

Certain actions may only be available for particular services as defined in the service-to-action mappings 518. The service-to-action mappings 518 specify the actions that are enabled for specific services, such as the services 406A-406B and 408A-408B of FIG. 4. When the reference incident 512 is identified, it is inherently associated with a service. The identifier of that service can be used as a lookup key to query the service-to-action mappings 518 and retrieve the set of actions that are specifically enabled for that service. This ensures that the surfaced actions are contextually relevant to the service associated with the incident. When the user 514 interacts with the reference incident 512 to retrieve or view available actions (such as described with respect to FIG. 7), the available action identification tool 502 evaluates user-specific considerations, such as team affiliation, role, and access permissions, to identify only the actions of the actions based on the service-to-action mappings that the user 514 is authorized to perform.

The available action identification tool 502 dynamically generates a set of data (i.e., available actions data) containing all actions available to the user 514, along with associated action attributes that provide further context for the recommendations. These attributes may include (1) the incidents (e.g. identifiers thereof) in which the action was invoked (by some user and/or programmatically) in the past, (2) the total count of user invocations of the action, and (3) the timestamp of the most recent invocation of the action. This set of attributes enable subsequent tools, such as the connected incidents identification tool 504, to determine relationships between available actions and historical incidents.

By filtering actions through both service-specific mappings and user-level permissions, the available action identification tool 502 ensures that only relevant and executable actions are surfaced for consideration in the recommendation process.

The connected incidents identification tool 504 identifies connected incidents from the incident store 516 based on the available actions data generated by the available action identification tool 502. Connected incidents are defined as historical incidents that previously ran one or more actions currently available to the reference incident 512 as determined by the available action identification tool 502. In other words, connected incidents are historical incidents in which one or more actions of the available actions data were invoked.

As described previously, the reference incident 512 is inherently tied to a service, and the service-to-action mappings 518 specify the actions enabled for that service. Actions may also span multiple services, meaning that more than one service may be configured to use an action, or an action may be enabled for multiple services. Accordingly, the connected incidents can include incidents associated with (e.g., processed through or by) different services, provided that at least one shared action was invoked.

The connected incidents identification tool 504 queries the incident store 516 to retrieve at least a subset of all historical incidents that (1) involved the invocation of the available actions and, optionally, (2) occurred within a configurable time window (e.g., within the last 3 months) relative to the current time. This filtered subset of historical incidents forms the set of “connected incidents” for the reference incident 512.

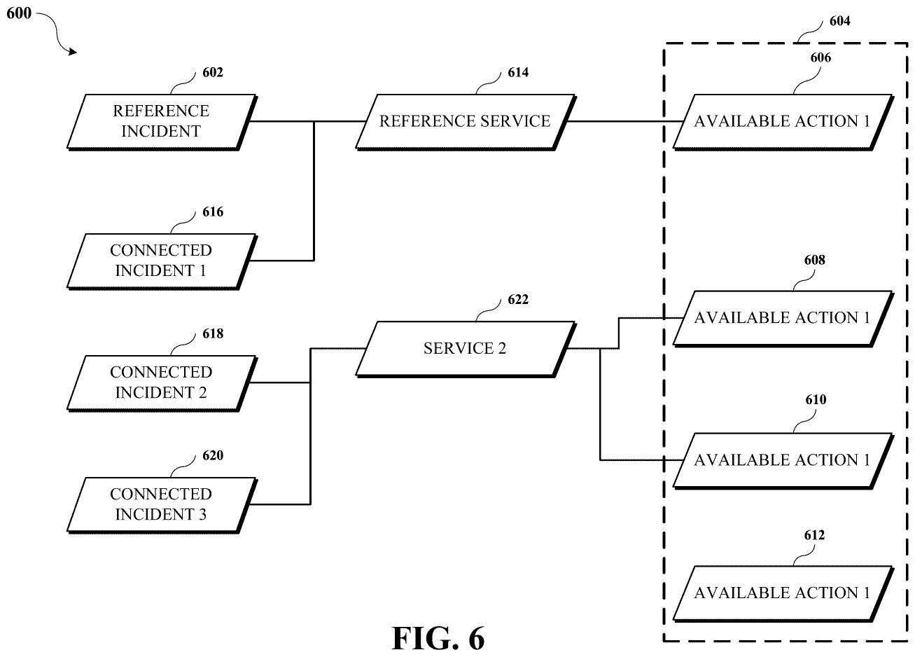

FIG. 6 illustrates an example 600 of identifying connected incidents by the connected incidents identification tool 504 for a reference incident 602, which can be the reference incident 512 of FIG. 5. The connected incidents identification tool 504 receives an available actions data 604 from the available action identification tool 502. The available actions data 604 is shown as including available actions 606-612. The available actions 602-612 are actions that the reference incident 602, through its associated service (e.g., the reference service 614), is eligible to have invoked thereupon.

As shown, the reference incident 602 is tied to a reference service 614, and the available actions data 604 includes the available action 606 for the reference service 614. The connected incidents identification tool 504 identifies historical incidents that previously invoked one or more of the available actions 606-612 included in the available actions data 604. In this example, three connected incidents have been identified: connected incidents 616, 618, and 620.

The connected incident 616 is associated with the reference service 614 and previously invoked the available action 606. The connected incident 618 and the connected incident 620 are associated with a service 622, which also has access to actions from the available actions data 604. Specifically, the connected incident 618 invoked the available action 608, and the connected incident 620 invoked the available action 610. As already mentioned, the ability for actions to span multiple services, enables the connected incidents identification tool 504 to identify connected incidents that are tied to different services but share one or more actions with the reference incident 602. The example 600 further illustrates that no connected incident is identified based on the available action 612.

To restate, the connected incidents identification tool 504 queries the incident store 516 to identify historical incidents with respect to which the available actions 606-612 were invoked (e.g., executed or performed). By identifying connected incidents based on shared actions, the connected incidents identification tool 504 surfaces relevant past incidents, including incidents from other services, that provide actionable insights for resolving the reference incident 602.

Referring again to FIG. 5, the connected incidents ranking tool 506 prioritizes the connected incidents identified by the connected incidents identification tool 504 based on their relevance to the reference incident 512. In an example, the ranking process involves calculating, for each of the connected incidents, a respective composite similarity score that integrates multiple dimensions, including textual, temporal, categorical, and/or performance-based factors.

The connected incidents ranking tool 506 calculates a similarity score between the reference incident 512 and each connected incident based on multiple dimensions derived from relevant incident attributes. These dimensions may include both categorical and continuous attributes that collectively inform the overall similarity measurement. Categorical attributes represent discrete, qualitative values that belong to specific categories or groups, such as a service identifier or User identifier; and continuous attributes represent measurable, quantitative values that exist on a numerical scale, such as timestamps or similarity scores.

In an example, the dimensions may include at least a subset of the service identifier (Service ID), an escalation policy identifier (EP ID), the user running action on incident (i.e., “running user”), temporal similarity, and textual similarity. Other dimensions are possible.

The service identifier (Service ID) is a categorical attribute representing the specific service associated with an incident. If a connected incident shares the same Service ID as the reference incident, it indicates that both incidents pertain to the same service, thereby increasing their similarity score.

Categorical attributes, such as service identifiers, cannot be directly used in similarity models because they are non-numeric and lack an inherent mathematical relationship. Unlike continuous variables, categorical attributes represent discrete labels or groups (e.g., different services), which cannot be meaningfully compared or processed in their raw form. To illustrate, consider three services with system-assigned identifiers AUTH_001, PAY_002, ID: USER_003. These identifiers have no inherent ordinal relationship—it cannot be said that AUTH_001 is “closer to” or “more similar to” PAY_002 than it is to USER_003, nor can mathematical operations like averaging AUTH_001 and PAY_002 be performed thereon.

To enable their inclusion in mathematical models, categorical attributes are converted into, what is referred to herein as, “dummy vectors,” where each category is represented as a vector of binary flags (0 or 1). This transformation enables the connected incidents ranking tool 506 to quantify the presence or absence of specific categories, enabling a structured comparison between incidents based on categorical attributes.

Again, the connected incidents ranking tool 506 processes categorical attributes, such as Service IDs and the other categorical attributes, by transforming them into dummy vectors for inclusion in the similarity model. Categorical variables are encoded as binary flags. For instance, with respect to the service identifiers, each service is assigned a dedicated flag, with a value of 1 indicating the incident's association with that service and a value of 0 otherwise, such as shown in Table I, which is based on the connected incidents described with respect to FIG. 6:

TABLE I

| Connected Incident ID | flag_reference_service | flag_service_2 |
|---|---|---|
| Connected Incident 612 | 1 | 0 |
| Connected Incident 614 | 0 | 1 |
| Connected Incident 616 | 0 | 1 |

In Table I, connected incidents are transformed into dummy vectors where flag_reference_service and flag_service_2 represent distinct services. For connected incident 616, the flag_reference_service is 1, indicating that it shares the same service as the reference incident 602, whereas for the connected incident 618 and the connected incident 620, flag_service_2 is flagged as 1, indicating their association with a service other than the service that the reference incident is associated with. This dummy vector representation enables the similarity model to quantitatively evaluate and compare the Service ID categorical attribute, contributing to the composite similarity score for connected incidents.

The escalation policy identifier (EP ID) is another categorical attribute that denotes the escalation policy linked to an incident. An escalation policy is an object associated with an incident and defines the order of responsibility for responding to issues detected on a service, particularly when immediate action is required. An escalation policy effectively dictates the incident response patterns within an organization and is typically configured to align with its specific operational needs. To illustrate, an escalation policy may indicate that if a responsible respondent does not respond to an incident within a defined time (e.g., 3 hour), then the incident is escalated and re-assigned to another specified responder. A matching EP ID between the reference incident and a connected incident suggests that both incidents follow the same escalation procedures, contributing positively to their similarity assessment.

This categorical attribute can also be converted to a dummy vector in a similar way described with respect to the service identifier categorical attribute. For example, two flags may be used: same_ep_flag and different_ep_flag, where if a connected incident shares the same escalation policy identifier (EP ID) as the reference incident, the same_ep_flag is set to 1 and the different_ep_flag is set to 0. Conversely, if the EP ID of the connected incident is different from that of the reference incident, the same_ep_flag is set to 0 and the different_ep_flag is set to 1. This binary encoding allows the similarity model to distinguish between incidents with matching and non-matching escalation policies and contributes to the composite similarity score used for ranking connected incidents.

The user running action on incident (i.e., the “running user”) is also a categorical attribute that captures whether the user (e.g., the user 514) attempting to perform an action on the reference incident (e.g., the reference incident 512) has performed actions on the connected incident. If the user 514 involved in the reference incident has previously executed actions on a connected incident, this commonality enhances the similarity score due to the user's consistent interaction patterns.

This categorical attribute can also be converted to a dummy vector in a similar way described with respect to the service identifier and escalation policy identifier (EP ID) categorical attributes. For example, two flags may be used: same_user_flag and different_user_flag, where if the connected incident involves the same user (the “running user”) who performed actions on the reference incident, the same_user_flag is set to 1 and the different_user_flag is set to 0. Conversely, if the user associated with the connected incident is different from the user associated with the reference incident, the same_user_flag is set to 0 and the different_user_flag is set to 1. This binary encoding enables the similarity model to quantify user-level overlap between incidents, allowing it to capture patterns of user activity that may indicate shared operational or troubleshooting behaviors, which contributes to the composite similarity score used for ranking connected incidents.

The temporal similarity, based on the last action run timestamp, is a continuous attribute that measures the recency of actions performed on incidents relative to a reference timestamp. Incidents with more recent action invocations thereon are considered more relevant to the reference incident 512. The connected incidents ranking tool 506 calculates temporal similarity as a normalized metric ranging from 0 to 1, where a value closer to 1 indicates greater recency and, therefore, higher relevance. The temporal similarity (TP) between the reference incident 512 (i.e., the reference incident) and a connected incident (CIᵢ) can be calculated using the following formula, where RT is a reference timestamp:

$${TP}_{{CI}_{i}} = 1 - \frac{time between Last Action of {CI}_{i} and a RT}{time between earliest Last Action Run of all CIs and the RT}$$

In some implementation, the Last Action Run timestamp of each connected incident is compared against the current timestamp (i.e., RT=current timestamp), treating the present moment as the reference timestamp. In other implementations, such as during testing of the algorithm, the Last Action Run timestamp of each connected incident is compared against a reference Invocation Run timestamp, simulating the current timestamp at the time the action was performed. This approach enables the connected incidents ranking tool 506 to account for historical contexts more accurately when evaluating temporal proximity.

The resulting temporal similarity score is a continuous metric that reflects the relative recency of the Last Action Run timestamp. Incidents with actions performed recently will receive higher scores, whereas more dormant incidents with older timestamps will score lower. By applying this temporal decay model, the connected incidents ranking tool 506 assigns higher weights to connected incidents with more recent activity, ensuring that temporal relevance is prioritized in the similarity assessment.

The textual similarity of the incident titles is a continuous attribute that evaluates the semantic resemblance between the titles of the reference incident and a connected incident. The connected incidents ranking tool 506 can measure textual similarity using a Term Frequency-Inverse Document Frequency (TF-IDF) model with light custom parameterization. The TF-IDF model assigns greater weight to tokens that occur more frequently in a specific document but less frequently across all other documents, enabling a quantitative assessment of similarity based on shared terms.

To achieve optimal accuracy and efficiency, the TF-IDF model may be customized (e.g., implemented) as follows. An N-gram range is set to (1, 1), meaning that all tokens are treated as singular words. An N-gram range is set to (1,1), meaning that all tokens are treated as singular words. For example, when processing an incident title like “Database Connection Timeout,” the model only considers individual words as tokens: “Database,” “Connection,” and “Timeout.” This contrasts with wider N-gram ranges such as (1,2), which would additionally consider consecutive word pairs like “Database Connection” and “Connection Timeout” as tokens, or (1,3), which would further include three-word sequences like “Database Connection Timeout.”

The TF-IDF model can be further customized as follows. A single character qualifies as a token, which diverges from the default behavior of requiring two or more characters. Original casing of the text is maintained rather than converting all characters to lowercase or uppercase. Tokens that appear in more than 95% of connected incident titles are dropped, as such common terms provide minimal value for differentiation. For empty incident titles, the title is replaced with a placeholder, such as a “-” character. Additionally, underscores (“_”) within incident titles are replaced with spaces to improve tokenization and semantic alignment.

The resulting tokenized incident titles are transformed into TF-IDF vectors, where each element represents the TF-IDF weight of a token in the title. The similarity between two titles is then calculated using cosine similarity between their respective TF-IDF vectors. Specifically, two incident titles containing the same rare word will have higher similarity because the corresponding TF-IDF scores for that word will be relatively higher. This approach provides a balance between accuracy and computational efficiency.

Other models for calculating the textual similarity may include cosine similarity with word embeddings, Jaccard similarity, and more advanced natural language processing (NLP) techniques such as Word2Vec, BERT (Bidirectional Encoder Representations from Transformers), or sentence transformers. For example, cosine similarity with word embeddings calculates similarity using vectorized representations of words in a multi-dimensional space, while BERT-based models leverage contextual word relationships to provide highly accurate semantic similarity scores.

By integrating these dimensions, the connected incidents ranking tool 506 computes a composite similarity score for each connected incident with respect to the reference incident 512 using any number of techniques. In an example, a cosine similarity algorithm is used. The cosine similarity framework is particularly well-suited for this setup, as it allows for a mix of binary features (categorical attributes) and continuous features while producing a similarity score ranging from 0 to 1. Because all input values are non-negative, the range of [−1,0) is not applicable in this context.

The similarity score is derived from the five features: three binary (Service ID, Service EP ID, and running user) and two continuous (Last Action Run timestamp and Incident Title textual similarity). Recognizing that each feature contributes differently to predicting the action(s) that were taken or will be taken, the connected incidents ranking tool 506 applies predefined weights to reflect their relative importance. In one example, the following weights are used: the incident title (textual similarity) feature is assigned a weight of 36%; the last action run timestamp (temporal similarity) feature is assigned a weight of 29%; the running user feature is assigned a weight of 21%; the service ID feature is assigned a weight of 7%; and the escalation policy identifier feature is assigned a weight of 7%.

The weighted similarity scoring ensures that features such as textual similarity and temporal proximity, which are more predictive of relevant connected incidents, contribute more significantly to the composite score. By applying these weights within the Cosine Similarity framework, the connected incidents ranking tool 506 ranks the connected incidents in order of relevance to the reference incident 512. This ranking enhances the accuracy and effectiveness of subsequent action recommendations generated by the recommended actions selection tool 508.

The recommended actions selection tool 508 identifies relevant actions to recommend (e.g., to mark or tag as recommended) by analyzing the actions previously applied to the k most similar incidents. The recommended actions selection tool 508 examines actions performed on a predefined top k (e.g., k=5) most similar incidents (where k can be adjusted as needed to balance between relevance and variety of recommendations). The top k similar connected incidents are selected, using the k-nearest neighbors framework (e.g., algorithm), based on the calculated similarity score. Similarity can be measured in any number of ways, including using cosine similarity.

Actions applied to the k most similar connected incidents are ranked using a multi-factor evaluation process that considers, first, invocation frequency (the number of times the action has been run by users); second, temporal recency (when the action was last run by users); and third, creation date (when the action was created or configured in the system 400). Actions performed frequently in similar incidents and those applied recently are prioritized, while older or less relevant actions are deprioritized.

The recommended actions selection tool 508 may further incorporate action-specific considerations, such as whether the actions contributed to or were otherwise helpful in resolving the k similar incidents, which can be determined by, for example, textual analysis of notes added to the k similar incidents by responders. For example, notes associated with an incident may be provided to a language processing model, such as a large language model (LLM) with a prompt requesting a binary response to whether the notes associated with an incident indicate that an action contributed to or was otherwise helpful in resolving the incident.

The ranked actions are then passed to the recommended actions display tool 510 for presentation to the user. All actions that the user can invoke are returned, each with an associated ranking (order) and a flag indicating whether the action is recommended. While all available actions are displayed to the user, only a configurable subset of the highest-ranked actions (e.g., the top N actions) are tagged as recommended, ensuring that users can distinguish the most relevant actions while still maintaining access to the complete set of available actions. In an example, the remaining actions (i.e., the non-recommended actions) may also be similarly sorted but without being flagged as recommended. In an example, the recommended actions selection tool 508 may provide an object (e.g., a structured object) of the actions to the recommended actions display tool 510.

To further illustrate the structured object, JSON is assumed herein; however other implementations are possible. Each JSON object may contain three keys: rank, indicating the position of the action in the sorted recommendation list; action_id, identifying the unique action associated with the recommendation; and rec_flag, a Boolean value that specifies whether the action is flagged as recommended (e.g., True for recommended actions and False for others). This list is ordered by rank, so that the most relevant actions appear first, followed by the remaining non-recommended actions, which are sorted in a similar manner but lack the recommendation flag.

For example, the JSON structure may be: {{‘rank’: 1, ‘action_id’: 11456, ‘rec_flag’: True}, {‘rank’: 2, ‘action_id’: 53267, ‘rec_flag’: True}, {‘rank’: 3, ‘action_id’: 98326, ‘rec_flag’: False}}. As such, the actions with action identifiers 11456 and 53267 are identified a recommended actions.

The recommended actions display tool 510 presents the recommended actions to the user 514 in a user interface associated with the action recommendation software 500 or the system 400 of FIG. 4. An example of a user interface is described with respect to FIG. 7.

The incident store 516 serves as a centralized data repository for storing historical incident records and associated action data. Each incident record includes structured attributes such as service identifiers, escalation policy identifiers, severity classifications, and textual descriptions, as well as metadata for actions performed on the incidents. The metadata includes timestamps, user identities, invocation success indicators, and resolution metrics such as effort estimates and completion times. The incident store supports query operations performed by the connected incidents identification tool 504, enabling retrieval of relevant historical incidents for similarity analysis. Additionally, the incident store 516 provides data to the ranking and selection tools to evaluate action relevance, success rates, and invocation patterns.

FIG. 7 illustrates an example of a user interface 700 for displaying recommended actions. The user interface 700 can be provided (e.g., generated, displayed, output, etc.) by action recommendation software, such as the action recommendation software 500 of FIG. 5. The user interface 700 shows details of an incident, which may be the reference incident 512 of FIG. 5. The user interface 700 can be displayed on a user device of a user, who may be the user 514 of FIG. 5. A control 702, when invoked by the user, causes a panel 704 to be displayed. The panel 704 enables the user to select actions to run (execute) with respect to the incident. As described herein, the list of actions displayed in the panel 704 are those available to the user. A control 706 enables the user to sort the list of available actions based on a selected criterion. As shown, the user has selected to sort the list of available actions by “RECOMMENDED.”

The list of available actions includes at least actions 708A-708C, where actions 708A and 708B are recommended actions, as illustrated by a tag 710. Each action is displayed with relevant metadata, such as the action name and a brief description. For example, action 708A (“APP DIAGNOSTICS”) and action 708B (“BACKEND FIX”) are explicitly marked as “RECOMMENDED,” visually distinguishing them from non-recommended actions like action 708C (“AUTOMATE FUNCTION”). The user interface 700 assists the user in efficiently identifying and selecting actions most relevant to resolving the incident, as determined by the recommendation system described herein. When the user selects an action, the action is executed with respect to the current incident.

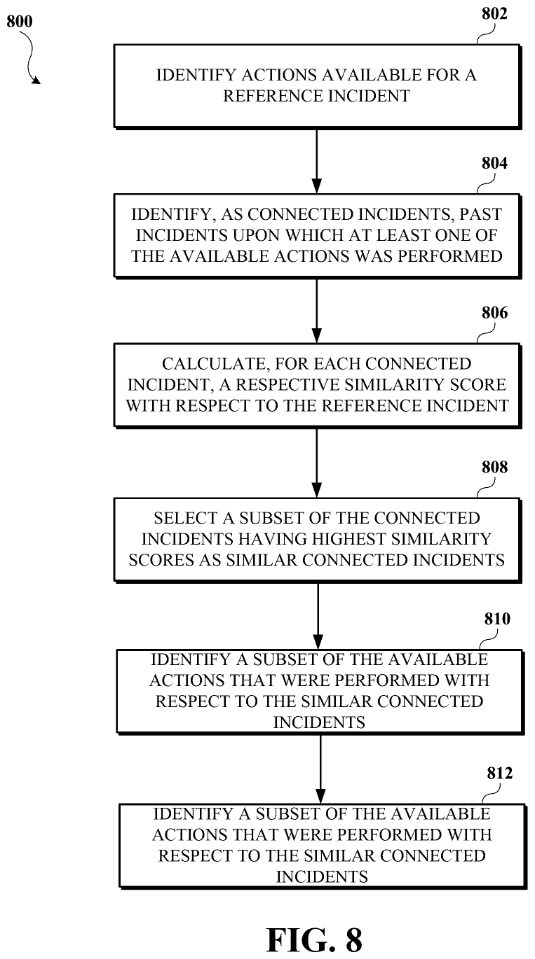

To further describe some implementations in greater detail, reference is next made to examples of techniques for identifying and presenting recommended actions. FIG. 8 is an example of a flowchart of a technique 800 for identifying recommended action with respect to a reference incident. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800 or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 802, actions available for the reference incident are identified. In an example, this identification process may involve accessing service-to-action mappings and/or evaluating user-specific considerations, such as team affiliation, role, and access permissions, to determine which actions the user is authorized to perform. At 804, connected incidents are identified from past incidents upon which at least one of the available actions was performed. This identification involves accessing a database of past incidents and associated actions to select incidents having at least one action in common with the available actions. The connected incidents identification process ensures that only relevant past incidents that share contextual similarities with, and can serve as proxies for, the reference incident are considered.

At 806, for each connected incident, a respective similarity score is calculated with respect to the reference incident. The similarity score calculation may incorporate multiple weighted features, with different features being assigned different weights based on their predictive importance. These features are derived from service identifiers, escalation policy identifiers, user identifiers, temporal proximity, and incident titles. A temporal similarity component is determined based on the time difference between the last action timestamp of each connected incident and a reference timestamp, normalized against the maximum time difference across all connected incidents.

At 808, a subset of the connected incidents having the highest similarity scores is selected as similar connected incidents. This selection process may apply a k-nearest neighbors framework to identify the most relevant historical incidents based on the calculated similarity scores. At 810, a subset of the available actions that were performed with respect to the similar connected incidents is identified. In an example, these actions, along with all other available actions, are then ranked based on their frequency of use in the similar connected incidents, with ties being resolved based on the most recent use of the actions. In an implementation, each of the subset of actions identified at 810 is assigned a “True” flag as relevant and is moved to the top of the ranked list of available actions. At 812, the identified subset of actions is provided (such as to the user) as recommended actions for the reference incident. These recommended actions are visually distinguished (such as with a “RECOMMENDED” tag or some other distinguishing visual marking) from other available actions in the user interface to help users quickly identify the most relevant actions.

Some implementations are described below as numbered examples (Example 1, 2, 3, etc.). These examples are provided as examples only and do not limit the other implementations disclosed herein.

Example 1: A method for recommending actions for incident management includes identifying actions available for a reference incident, identifying, as connected incidents, past incidents upon which at least one of the available actions was performed, calculating, for each connected incident, a respective similarity score with respect to the reference incident, selecting a subset of the connected incidents having highest similarity scores as similar connected incidents, identifying a subset of the available actions that were performed with respect to the similar connected incidents, and providing the subset of the available actions as recommended actions for the reference incident.

Example 2: The method of Example 1, wherein calculating the respective similarity score includes generating a weighted combination of multiple similarity features, where different features are assigned different weights, and wherein the multiple similarity features are based on at least two of service identifiers, escalation policy identifiers, user identifiers, temporal proximity, or incident titles.

Example 3: The method of Example 1, wherein calculating the respective similarity score includes determining a temporal similarity between the reference incident and one of the connected incidents based on a time difference between a last action timestamp of the one of the connected incidents and a reference timestamp, and a maximum time difference between last action timestamps of all of the connected incidents and the reference timestamp.

Example 4: The method of Example 1, wherein identifying the connected incidents includes accessing a database of past incidents and associated actions and selecting past incidents having at least one action in common with the available actions.

Example 5: The method of Example 1, further including ranking actions within the subset of the available actions based on frequency of use in the similar connected incidents.

Example 6: The method of Example 5, wherein ranking actions further includes, in case of equal frequency of use, ranking based on most recent use.

Example 7: The method of Example 1, further including visually marking the recommended actions from other available actions in a user interface.

Example 8: A system includes one or more memories and one or more processors, the one or more processors configured to execute instructions stored in the one or more memories to identify actions available for a reference incident, identify, as connected incidents, past incidents upon which at least one of the available actions was performed, calculate, for each connected incident, a respective similarity score with respect to the reference incident, select a subset of the connected incidents having highest similarity scores as similar connected incidents, identify a subset of the available actions that were performed with respect to the similar connected incidents, and provide the subset of the available actions as recommended actions for the reference incident.

Example 9: The system of Example 8, wherein to calculate the respective similarity score includes to generate a weighted combination of multiple similarity features, where different features are assigned different weights, and wherein the multiple similarity features are based on at least two of service identifiers, escalation policy identifiers, user identifiers, temporal proximity, or incident titles.

Example 10: The system of Example 8, wherein to calculate the respective similarity score includes to determine a temporal similarity between the reference incident and one of the connected incidents based on a time difference between a last action timestamp of the one of the connected incidents and a reference timestamp, and a maximum time difference between last action timestamps of all of the connected incidents and the reference timestamp.

Example 11: The system of Example 8, wherein to identify the connected incidents includes to access a database of past incidents and associated actions and select past incidents having at least one action in common with the available actions.

Example 12: The system of Example 8, wherein the one or more processors are further configured to execute instructions stored in the one or more memories to rank actions within the subset of the available actions based on frequency of use in the similar connected incidents.

Example 13: The system of Example 12, wherein to rank actions further includes to, in case of equal frequency of use, rank based on most recent use.

Example 14: The system of Example 8, wherein the one or more processors are further configured to execute instructions stored in the one or more memories to visually mark the recommended actions from other available actions in a user interface.

Example 15: One or more non-transitory computer readable media storing instructions operable to cause one or more processors to perform operations including identifying actions available for a reference incident, identifying, as connected incidents, past incidents upon which at least one of the available actions was performed, calculating, for each connected incident, a respective similarity score with respect to the reference incident, selecting a subset of the connected incidents having highest similarity scores as similar connected incidents, identifying a subset of the available actions that were performed with respect to the similar connected incidents, and providing the subset of the available actions as recommended actions for the reference incident.

Example 16: The one or more non-transitory computer readable media of Example 15, wherein calculating the respective similarity score includes generating a weighted combination of multiple similarity features, where different features are assigned different weights, and wherein the multiple similarity features are based on at least two of service identifiers, escalation policy identifiers, user identifiers, temporal proximity, or incident titles.

Example 17: The one or more non-transitory computer readable media of Example 15, wherein calculating the respective similarity score includes determining a temporal similarity between the reference incident and one of the connected incidents based on a time difference between a last action timestamp of the one of the connected incidents and a reference timestamp, and a maximum time difference between last action timestamps of all of the connected incidents and the reference timestamp.

Example 18: The one or more non-transitory computer readable media of Example 15, wherein identifying the connected incidents includes accessing a database of past incidents and associated actions and selecting past incidents having at least one action in common with the available actions.

Example 19: The one or more non-transitory computer readable media of Example 15, the operations further including ranking actions within the subset of the available actions based on frequency of use in the similar connected incidents.

Example 20: The one or more non-transitory computer readable media of Example 19, wherein ranking actions further includes, in case of equal frequency of use, ranking based on most recent use.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PHP, Perl, JavaScript, Ruby, VBScript, Microsoft.NET™ languages such as C #, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
identifying actions available for a reference incident;
identifying, as connected incidents, past incidents upon which at least one of the available actions was performed;
calculating, for each connected incident, a respective similarity score with respect to the reference incident;
selecting a subset of the connected incidents having highest similarity scores as similar connected incidents;
identifying a subset of the available actions that were performed with respect to the similar connected incidents; and
providing the subset of the available actions as recommended actions for the reference incident.

2. The method of claim 1, wherein calculating the respective similarity score comprises:
generating a weighted combination of multiple similarity features, wherein different features are assigned different weights, and wherein the multiple similarity features are based on at least two of service identifiers, escalation policy identifiers, user identifiers, temporal proximity, or incident titles.

3. The method of claim 1, wherein calculating the respective similarity score comprises:
determining a temporal similarity between the reference incident and one of the connected incidents based on: a time difference between a last action timestamp of the one of the connected incidents and a reference timestamp, and a maximum time difference between last action timestamps of all of the connected incidents and the reference timestamp.

4. The method of claim 1, wherein identifying the connected incidents comprises:
accessing a database of past incidents and associated actions; and
selecting past incidents having at least one action in common with the available actions.

5. The method of claim 1, further comprising:
ranking actions within the subset of the available actions based on frequency of use in the similar connected incidents.

6. The method of claim 5, wherein ranking actions further comprises:
in case of equal frequency of use, ranking based on most recent use.

7. The method of claim 1, further comprising:
visually marking the recommended actions from other available actions in a user interface.

8. A system, comprising:
one or more memories; and
one or more processors, the one or more processors configured to execute instructions stored in the one or more memories to:
identify actions available for a reference incident;
identify, as connected incidents, past incidents upon which at least one of the available actions was performed;
calculate, for each connected incident, a respective similarity score with respect to the reference incident;
select a subset of the connected incidents having highest similarity scores as similar connected incidents;
identify a subset of the available actions that were performed with respect to the similar connected incidents; and
provide the subset of the available actions as recommended actions for the reference incident.

9. The system of claim 8, wherein to calculate the respective similarity score comprises to:
generate a weighted combination of multiple similarity features, wherein different features are assigned different weights, and wherein the multiple similarity features are based on at least two of service identifiers, escalation policy identifiers, user identifiers, temporal proximity, or incident titles.

10. The system of claim 8, wherein to calculate the respective similarity score comprises to:
determine a temporal similarity between the reference incident and one of the connected incidents based on: a time difference between a last action timestamp of the one of the connected incidents and a reference timestamp, and a maximum time difference between last action timestamps of all of the connected incidents and the reference timestamp.

11. The system of claim 8, wherein to identify the connected incidents comprises to:
access a database of past incidents and associated actions; and
select past incidents having at least one action in common with the available actions.

12. The system of claim 8, wherein the one or more processors further configured to execute instructions stored in the one or more memories to:
rank actions within the subset of the available actions based on frequency of use in the similar connected incidents.

13. The system of claim 12, wherein to rank actions further comprises to:
in case of equal frequency of use, rank based on most recent use.

14. The system of claim 8, wherein the one or more processors further configured to execute instructions stored in the one or more memories to:
visually mark the recommended actions from other available actions in a user interface.

15. One or more non-transitory computer readable media storing instructions operable to cause one or more processors to perform operations comprising:
identifying actions available for a reference incident;
identifying, as connected incidents, past incidents upon which at least one of the available actions was performed;
calculating, for each connected incident, a respective similarity score with respect to the reference incident;
selecting a subset of the connected incidents having highest similarity scores as similar connected incidents;
identifying a subset of the available actions that were performed with respect to the similar connected incidents; and
providing the subset of the available actions as recommended actions for the reference incident.

16. The one or more non-transitory computer readable media of claim 15, wherein calculating the respective similarity score comprises:
generating a weighted combination of multiple similarity features, wherein different features are assigned different weights, and wherein the multiple similarity features are based on at least two of service identifiers, escalation policy identifiers, user identifiers, temporal proximity, or incident titles.

17. The one or more non-transitory computer readable media of claim 15, wherein calculating the respective similarity score comprises:
determining a temporal similarity between the reference incident and one of the connected incidents based on: a time difference between a last action timestamp of the one of the connected incidents and a reference timestamp, and a maximum time difference between last action timestamps of all of the connected incidents and the reference timestamp.

18. The one or more non-transitory computer readable media of claim 15, wherein identifying the connected incidents comprises:
accessing a database of past incidents and associated actions; and
selecting past incidents having at least one action in common with the available actions.

19. The one or more non-transitory computer readable media of claim 15, the operations further comprising:
ranking actions within the subset of the available actions based on frequency of use in the similar connected incidents.

20. The one or more non-transitory computer readable media of claim 19, wherein ranking actions further comprises:
in case of equal frequency of use, ranking based on most recent use.
